(19) United States
(12) Patent Application Publication
(10) Pub. No.: US 2026/0221742 A1
(43) Pub. Date: Jul. 30, 2026

(54) WIRING BRACKET THAT ATTACHES TO FRAME BOX MOUNT

(71) Applicant: FCA US LLC, Auburn Hills, MI (US)

(72) Inventors: Sebastian Edilberto Valdez Esquivel, Mexico City (MX); David J Kraft, Auburn Hills, MI (US); Christopher G Gomez, Auburn Hills, MI (US)

(21) Appl. No.: 19/040,381

(22) Filed: Jan. 29, 2025

(51) Int. Cl. H02G 3/32

(52) U.S. Cl. CPC H02G 3/32

(57) ABSTRACT

A routing bracket has a body member. A clip extends from the body member to snap fit into an aperture in a box mount to secure the body member. An attachment ledge couples with an edge of the box mount to position the body member on the box mount. An arm extends from the body member. The arm includes a member to receive a wire support.

### FIELD

The present disclosure relates to automotive vehicles and, more particularly, to a wiring bracket that attaches to an existing box mount.

### BACKGROUND

This section provides background information related to the present disclosure which is not necessarily prior art.

In automotive vehicles, in order to add a mounting bracket to an existing frame box mount, existing mounting clips require either a weld stud or a new hole for a fastener that is sized appropriately to receive the mounting clip. Thus, in order to adapt the clip or bracket to an existing frame, the clip or bracket must be adapted to fit the frame box mount. Thus, there is a need for wiring brackets to be attached to existing vehicle frame box mounts that do not require additional studs, add additional weight or parts.

Accordingly, the present disclosure provides a bracket that can attach to an existing manufacturing hole in the frame box mount, Also, it can be clipped to the top stamped edge of the frame box mount. Accordingly, wiring, hoses for cooling systems or hard and soft tubbing or the like can attached to the bracket utilizing standard fir tree clips. This enables the bracket to be attached, during assembly, by one hand and expedite manufacturing. Since the present disclosure includes a clipping feature and is adapted to secure with an existing hole of the frame box mount, additional changes and additional costs are not required. The present disclosure does not require a frame modification to adapt to existing clips. The present disclosure enables the clip to be assembled without special tools.

### SUMMARY

This section provides a general summary of the disclosure, and is not a comprehensive disclosure of its full scope or all of its features.

According to a first aspect of the disclosure, a routing bracket comprises a body member with an extending clip that snap fits into an aperture in a frame box mount to secure the body member to the box mount. An attachment ledge couples with an edge of the frame box mount to position the body member on the box mount. An arm extends from the body member. The arm includes a member to receive a wire support. The attachment ledge includes a skirt that provides a L-shape to secure it to the edge. The clip includes blocking arms to retain the clip in the aperture. The body member and extending arm provide an L-shape bracket. The arm includes a flange with the wire support receiving member. An aperture is in the body member adjacent the clip. The bracket is formed from a plastic material.

According to a second aspect of the disclosure, a vehicle frame cargo box mount including a bracket comprises at least one wall on the box mount. The at least one wall includes an aperture. The bracket comprises a body member with an extending clip to snap fit into the aperture in the box mount to secure the body member to the box mount. An attachment ledge couples with an edge of the box mount to position the body member on the box mount. An arm extends from the body member. The arm includes a member to receive a wire support. The attachment ledge includes a skirt that provides a L-shape to secure it to the edge. The clip includes blocking arms to retain the clip in the aperture. The body member and extending arm provide a L-shape bracket. The arm includes a flange with the wire support receiving member. An aperture is in the body member adjacent the clip. The bracket is formed from a plastic material.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective schematic view of a vehicle cargo box with a mount.

FIG. 2 is a front elevation view of the bracket on the mount.

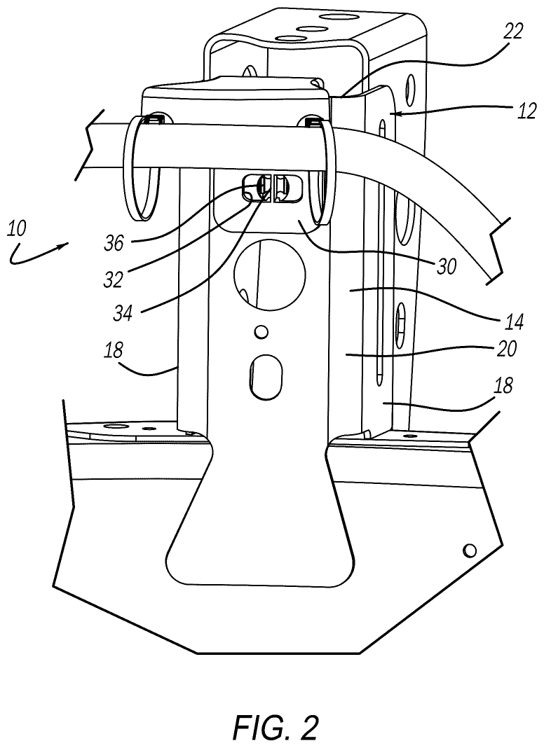

FIG. 3 is a rear perspective view of a bracket on the mount.

FIG. 4 is a side perspective view of the bracket on the mount.

Corresponding reference numerals indicate corresponding parts throughout the several views of the drawings.

### DETAILED DESCRIPTION

Example embodiments will now be described more fully with reference to the accompanying drawings.

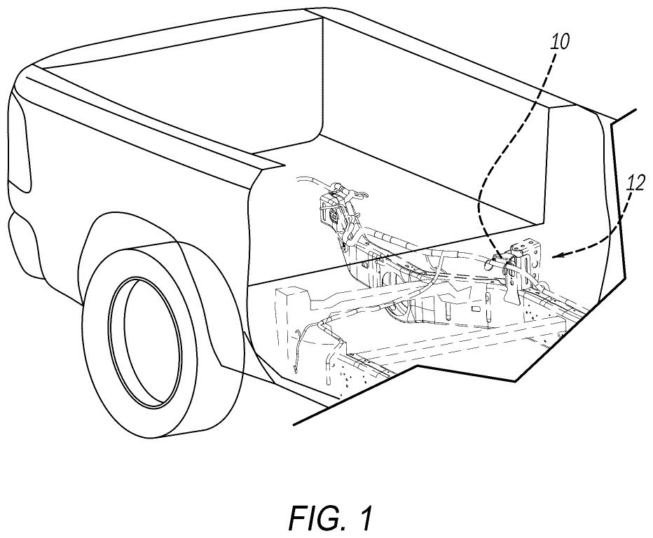

Turning to the figures, a bracket is illustrated and designated with the reference numeral 10. The bracket 10 is secured to a frame box mount 12. The box mount 12 includes a wall 14 with a manufacturers' aperture 16. The wall generally has a U-shape with a pair of legs 16, 18 connected by a web 20, that includes the aperture 16. The box mount 12 also includes an edge 22 at the terminus of the wall 14. The box mount 12 can be secured to a frame structure by conventional fasteners. The frame structure includes a cargo box as illustrated in FIG. 1.

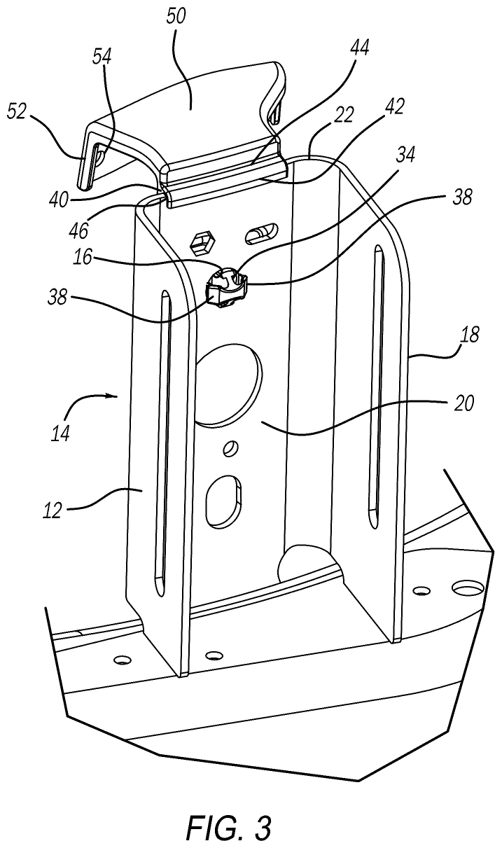

The bracket 10 includes a body 30 that has an overall rectangular configuration. The body 30 is relatively planar so that its back abuts against the box mount wall 14. The body 30 includes an aperture 32 adjacent a clip 34. The clip 34 is inserted into the wall aperture 16 and snap fits into the aperture to secure the body member 30 on the box member wall 14. The clip 34 includes legs 36 that secure it to the body 30. The mount bracket 10 is a plastic piece and therefore the legs 36 are molded with the body 30 and the aperture is formed during the forming of the plastic bracket 10. The clip 34 includes blocking arms 38 that project from the clip 34 that retain the clip 34 on the wall 14 once the clip 34 is positioned through the aperture 16 as illustrated in FIG. 3.

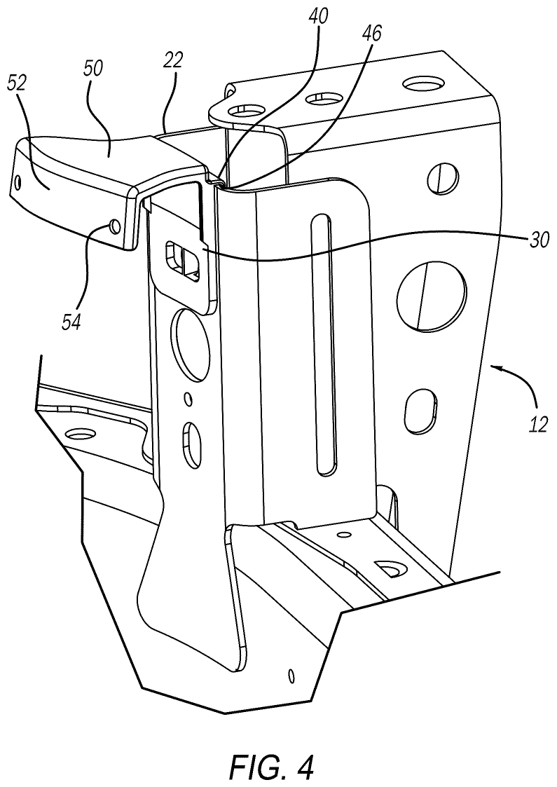

The body 30 includes an attachment ledge 40 that extends from a back surface of the body 30. The attachment ledge 40 has an overall L-shape configuration with a skirt 42 that extends from wall 44 to provide an L-shape for the attachment ledge 40. The L-shape ledge 40 has a channel 46 that is sized to fit over the wall edge 22 and couple the attachment ledge with the edge 22 of the body mount 12 to position the body member 30 on the box mount 12 as seen in FIG. 3. An arm 50 extends from the body 30. The arm 50 extends from the front of the body 30 and above the attachment ledge as illustrated in FIGS. 3 and 4. The extending arm 50 defines an L-shape with the body 30. The arm 50 includes a flange 52 to receive a wire support. The flange 52 includes apertures 54 that receive standard fir tree clips to secure the wire support with the bracket 10. The arm 50 has an overall rectangular configuration with a pair of curved sides 56. The arm 50 is generally planar, however, it could have any desirable shape that functions satisfactorily for its purpose. The front edge of the arm 58 is generally arcuate which, in turn, provides an arcuate flange 52.

Accordingly, the clip 34 is positioned into the manufacturing aperture 16 of the box mount wall 14. The clip 34 is continued to be pushed into aperture 14 until the blocking arms 38 are positioned behind the web 20 to secure the clip 34 in the aperture 16. Also, prior to this, the attachment ledge 40 is positioned over the mount edge 22. As this occurs, the clip 34 is pushed inward into the aperture 16 so that the bracket 10 is positioned on the box mount 12 as well as secured with the box mount wall 14. Then, a wiring support can be secured to the flange 52 via fir tree fasteners inserted into apertures 54 so that the wiring can pass the box mount.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A routing bracket comprising:
a body member;
a clip extending from the body member for snap fitting into an aperture in a box mount for securing the body member;
an attachment ledge for coupling with an edge of the box mount to position the body member on the box mount; and
an arm extending from the body member, the arm including a member for receiving a wire support.

2. The routing bracket of claim 1, wherein the attachment ledge includes a skirt, providing an L-shape, to secure to the edge.

3. The routing bracket of claim 1, wherein the clip includes blocking arms for retaining the clip in the aperture.

4. The routing bracket of claim 1, wherein the body member and extending arm provide a L-shape bracket.

5. The routing bracket of claim 1, wherein the arm includes a flange with the receiving member.

6. The routing bracket of claim 1, wherein the bracket is formed from plastic material.

7. The routing bracket of claim 1, wherein an aperture in the body member is adjacent the clip.

8. A vehicle box mount including a bracket comprising:
at least one wall on the box mount, the least one wall including an aperture, and a bracket comprising:
a body member;
a clip extending from the body member for snap fitting into an aperture in a box mount for securing the body member;
an attachment ledge for coupling with an edge of the box mount to position the body member on the box mount; and
an arm extending from the body member, the arm including a member for receiving a wire support.

9. The vehicle box mount including a bracket of claim 8, wherein the attachment ledge includes a skirt, providing an L-shape, to secure to the edge.

10. The vehicle box mount including a bracket of claim 8, wherein the clip includes blocking arms for retaining the clip in the aperture.

11. The vehicle box mount including a bracket of claim 8, wherein the body member and extending arm provide a L-shape bracket.

12. The vehicle box mount including a bracket of claim 8, wherein the arm includes a flange with the receiving member.

13. The vehicle box mount including a bracket of claim 8, wherein the bracket is formed from plastic material.

14. The vehicle box mount including a bracket of claim 8, wherein an aperture in the body member is adjacent the clip.
